(19) United States
(12) Patent Application Publication
(10) Pub. No.: US 2016/0171087 A1
(43) Pub. Date: Jun. 16, 2016

(54) METHOD AND DEVICE FOR USING CONTENT OF A CONTENT LIBRARY

(71) Applicant: ORANGE, Paris (FR)

(72) Inventors: Nicolas Doisy, Rennes (FR); Jerome Chauvel, Trevou Treguignec (FR); Sandrine Ville Eber, Thorigne-Fouillard (FR)

(21) Appl. No.: 14/960,021

(22) Filed: Dec. 4, 2015

(30) Foreign Application Priority Data
Dec. 11, 2014 (FR) 1462262

(51) Int. Cl. G06F 17/30; G06F 3/0482; G06F 3/0484

(52) U.S. Cl. CPC G06F 17/30601; G06F 3/04842; G06F 3/0482

(57) ABSTRACT

The invention concerns an instance of use of a content library, in particular the interactive viewing of the content of the library.

A subject of the invention is a method for using content of a content library comprising, following an instance of use of at least one content of a library, an instance of generation of a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

Thus, the proposed content groupings or clusters for the user have a greater probability of being selected by the user than content files classified by date or subject since they are devised by taking account of the previously used content.

The invention concerns an instance of use of a content library, in particular the interactive viewing of the content of the library.

Today, when a user wishes to view photographs and/or videos in his or her library, he or she is confronted by the problem of the amount of content in this library. The reason is that digital capture of content and the ease of storing the latter has vastly increased the amount of content available in personal content libraries.

Owing to the very large amount of content in a library, or of duplicated content, viewing the library can prove troublesome because a large reproduced amount of content is of no interest to the user at the time of viewing. Since viewing the whole content of a library is therefore of no interest to the user or impossible, means have been devised to assist the user in finding or relocating his or her content.

One solution proposed at present is thus to select some of the content according to one or more keywords before it is reproduced. In point of fact, the very large amount of content also makes it difficult to select the content in order to view it because it prompts the user to select one or more keywords from among a large number of keywords that are necessary for describing this large amount of content.

Another solution has been to arrange the content in files either by shooting date or by theme (album). This solution allows the content to be viewed by a reasonable amount of content for one viewing, that is to say so that the duration of viewing does not exceed a few minutes in connection with personal viewing, or 15-20 minutes in the case of projection to a group of people, for example. Since the user is thus limited to a single context, he or she takes little advantage of the content classified in this manner. And, when the user still wishes to use the content arranged in this manner outside the predetermined themes, he or she is confronted by the same selection problem as previously.

Moreover, when the content is scattered over various files in this manner, a user who is no longer interested in continuing to view the content of a file will have to make a new selection from among the large number of files.

It is for these reasons that the user generally relocates his or her content in accordance with a time criterion (shooting date, download date, etc.) or in alphanumeric order of content name.

One of the aims of the present invention is to overcome disadvantages of the prior art.

A subject of the invention is a method for using content of a content library comprising, following an instance of use of at least one content of a library, an instance of generation of a plurality of content clusters from the content of the library according to one or more criteria associated with the clusters, the criteria having been determined according to at least one previously used content, the generated clusters being selectable by a user, with an instance of selection of a cluster triggering an instance of use of the content of the selected cluster.

Thus, the proposed content groupings or clusters for the user have a greater probability of being selected by the user than content files classified by date or theme since they are devised by taking account of the previously used content.

Advantageously, the method for using content comprises an instance of selection of a cluster at the command of the user from among the following:
the generated clusters,
another cluster linked to the cluster currently being used by means of a bridge between a content of the cluster currently being used and a content of this other cluster.

Thus, the user does not have to select one by one the content of the collection that he or she wishes to see used from all the content of the library, nor one or more keywords from a large number of keywords describing all of the content of the library.

The user is therefore not confronted with a selection difficulty because the content is already grouped into content clusters (notably into theme clusters) and the number of clusters remains manageable, comprehensible by the user because it is reduced to clusters in connection with previously used content.

Advantageously, the method for using content comprises an instance of use of a first content selected by the user from the library, the use of the first content triggering the generation of content clusters according to one or more criteria determined according to the first content.

Thus, the user can simply indicate the content of the library that he or she wishes to view without selecting this content one by one, nor selecting a plurality of keywords, indeed having forgotten some of this content.

Advantageously, the method for using content comprises an instance of use of the content of a selected cluster triggered by the selection of said cluster at the command of the user.

Thus, viewing of the content of the library is interactive.

Advantageously, the method for using content comprises an instance of use of the content of a second cluster selected by the user, the generation of second content clusters according to one or more criteria determined according to at least one content of the first cluster being triggered by one of the following events:
the use of the last content of a first cluster,
cluster exit request from the user.

Thus, viewing of the content of the library is interactive and evolutionary.

Advantageously, the criteria are determined according to at least one information item among the following:
information items relating to the first content,
information items relating to previously used content of a cluster,
information items relating to at least one action of the user in relation to at least one previously used content of at least one cluster,
information items relating to at least one cluster selection command from the user.

By determining the criteria according to information items relating to the first content, this allows the user to direct, in simplified fashion, the use of the library.

By determining the criteria according to information items relating to previously used content of the cluster, this allows the use of the library to be evolved.

By determining the criteria according to action by the user in relation to at least one used content, this allows the user to interact in simplified fashion with the use of the library.

By determining the criteria according to the selection of a content cluster by a user, this allows interaction by the user with the use of the library to be of use for several evolutions of the use of the library: first of all, the use of the cluster of selected content and then the generation of new clusters, at least one of which will be used.

The combination of at least two of these information items allows the generation of a cluster that is more relevant in terms of the user's interest in use.

Advantageously, the criteria are determined according to information items relating to at least one instance of use of content of the library among the following instances of use:
an instance of use in progress,
at least one previous instance of use, the criteria being dependent on data backed up during the preceding use.

Thus, the use of the library evolves according to the user's current interest in use and/or the user's general interest in use.

Advantageously, the method for using content comprises an instance of data backup, the backed up data comprising at least some of the information items relating to used content, criteria, to selection commands for the use and to actions by the user during the use.

Thus, the information items being used to determine criteria for the use will allow clusters to be generated in a future instance of use.

Advantageously, the method for use comprises an instance of detection of a link between characteristics of content of two clusters, with the detection of a link triggering an instance of creation of a bridge between this content of these two clusters.

Thus, the use of the content will allow movement from one content cluster to another without new cluster generation. The bridges between clusters will promote the use of all of the generated clusters.

Advantageously, the link detection is carried out during the cluster generation.

Thus, the burden of processing is reduced because the link detection uses an analysis of the criteria allowing the clusters to be generated.

Advantageously, the method for use comprises an instance of creation of a bridge between clusters, a bridge being set up between a content of one cluster and a content of another cluster as soon as a link between characteristics of the content of the cluster and characteristics of the content of the other cluster is detected.

Advantageously, the method for use comprises an instance of use of a content associated with a bridge between the content of one cluster and a content of another cluster triggering an instance of suggestion of selection of the other cluster, the selection of the other cluster allowing triggering of an instance of use of the content of this other cluster beginning with the content associated with the bridge in this other cluster.

Advantageously, according to one implementation of the invention, the various steps of the method according to the invention are implemented by a piece of software or a computer program, this software comprising software instructions that are intended to be executed by a data processor of a device for using content and that are designed to control the execution of the various steps of this method.

The aim of the invention is therefore also a program comprising program code instructions for executing the steps of the method for using content when said program is executed by a processor.

This program can use any programming language and be in the form of source code, object code or intermediate code between source code and object code, such as in a partially compiled form or any other desirable form.

A subject of the invention is likewise a device for using content of a content library comprising a cluster generator, the generator supplying, following an instance of use of at least one content of a library, a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

A subject of the invention is likewise a terminal comprising:
A module for using content
A cluster generator supplying, following an instance of use of at least one content of a content library, a plurality of content clusters from the content of the library according to one or more criteria associated with the clusters, the criteria having been determined according to at least one content previously used by the module for use, the generated clusters being selectable by a user, an instance of selection of a cluster triggering an instance of use of the content of the selected cluster.

The features and advantages of the invention will become more clearly apparent upon reading the description, provided for example, and the figures relating thereto, in which:

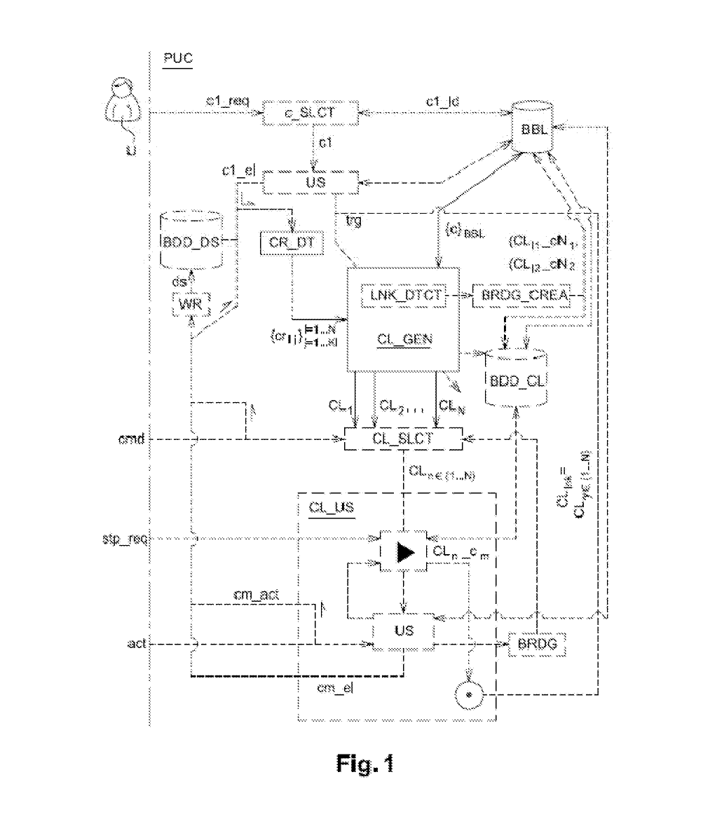

FIG. 1 shows a simplified diagram of a method for using content of a library according to the invention,

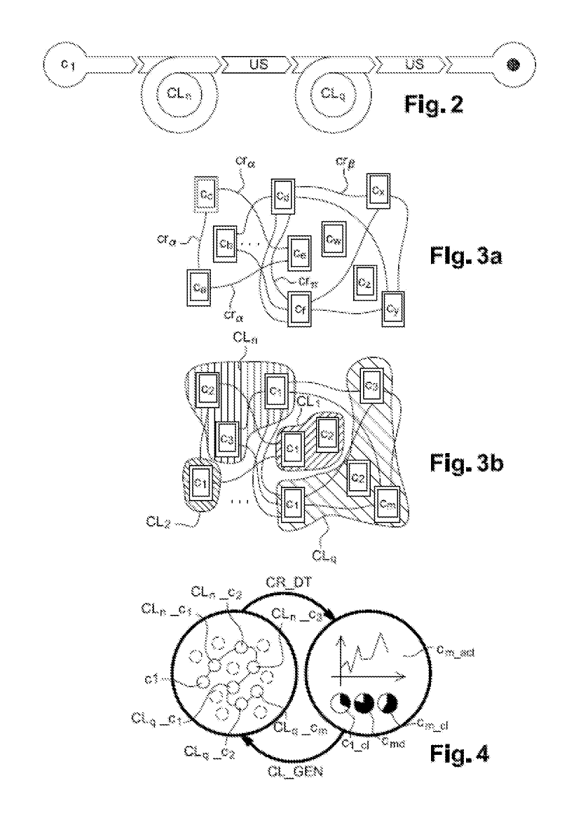

FIG. 2 shows a sequential diagram of the dynamic use of a content library, according to the invention,

FIGS. 3a and 3b show respective simplified diagrams of the links between the characteristics of the content, and of the content clusters, according to the invention,

FIG. 4 shows an abstract diagram of the dependence between the route for use of a content library and the evolutionary criteria, according to the invention,

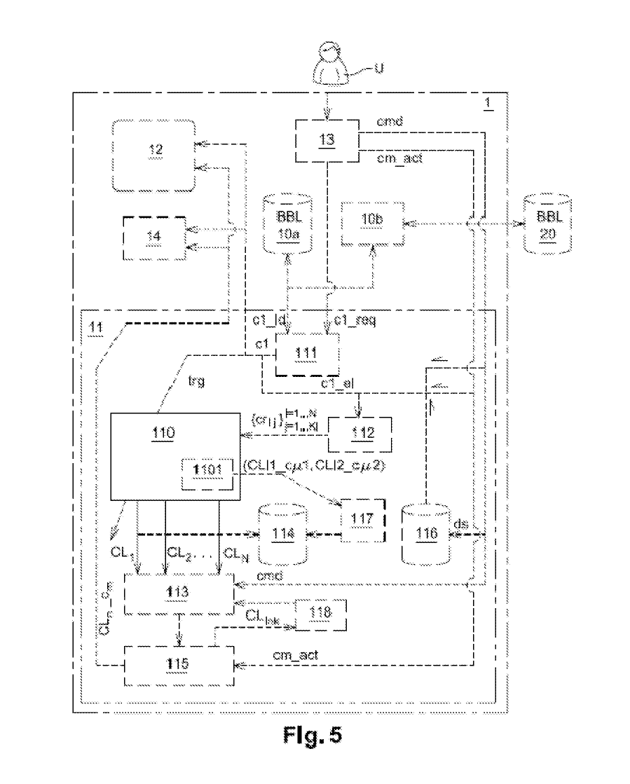

FIG. 5 shows a simplified diagram of a device for using content of a library according to the invention.

FIG. 1 illustrates a simplified diagram of a method for using content of a content library according to the invention.

The method for using content PUC of a content library BBL comprises, following an instance of use US of at least one first content c1, cm of a library BBL, an instance of generation CL_GEN of a plurality of content clusters CL₁, CL₂ . . . CL_{N} from the content of the library BBL according to one or more criteria associated with the clusters

$${\{ {cr}_{ij} \}}_{i = 1 … N \\ j = 1 … {K}_{i}} .$$

The criteria crᵢⱼ have been determined CR_DT according to at least one first previously used content c1, cm. The generated clusters CL₁ . . . CL_{N} are selectable CL_SLCT by a user U. An instance of selection of a cluster CL_SLCT triggers an instance of use US of the content of the selected cluster CLₙ.

In particular, the method for using content PUC comprises an instance of selection of a content c_SLCT by a user U. The user U sends, for example by means of a user interface (not illustrated in FIG. 1), a request for a content c1 among the content of the content library. The method for use PUC then selects c_SLCT this first content c1 from the library BBL in order to use it US, notably by loading c1_Id the content.

In particular, when the use of the library starts, this selected content is the first content used. The method for using content PUC comprises, therefore, an instance of use US of a first content c1 selected by the user U from the library BBL. The use US of the first content c1 triggers the generation of content clusters CL_GEN according to one or more criteria determined according to the first content c1. This step is also called the onset, because it starts the use of the library.

Thus, the user can simply indicate the content of the library that he or she wishes to view without selecting this content one by one, nor selecting a plurality of keywords, indeed comprising forgotten some of this content.

In particular, the method for use PUC comprises the use US of this content c1 selected c_SLCT by the user U. The use US of the first content c1 selected c_SLCT by the user U triggers trg an instance of generation CL_GEN of content clusters CL₁ . . . CL_{N}, according to criteria associated with the clusters determined from this first content c1 selected by the user.

In particular, the method for use PUC comprises the determination CR_DT of the criteria

$${\{ {cr}_{ij} \}}_{i = 1 … N \\ j = 1 … {K}_{i}}$$

according to the first content c1 selected c_SLCT by the user U.

In particular, the method for use PUC comprises an instance of selection CL_SLCT by the user U of a cluster thus generated according to the first content c1 in the course of use. The cluster selection CL_SLCT is notably triggered by the user U by means of a command cmd. For example, the command cmd has an identifier for the cluster chosen by the user U.

In particular, the method for use PUC comprises an instance of use CL_US of the selected content cluster CLn. The use of a content cluster CL_US comprises, notably, a successive or simultaneously reading [symbol] of the content CLₙ_{_}c_{1 . . .} CLₙ_{_}c_{M} of the selected cluster aₙand the use US of the read content CLₙ_{_}cₘ.

In particular, the method for using PUC content comprises, therefore, an instance of use of the content of a selected cluster US triggered by the selection of said cluster CL_SLCT commanded cmd by the user U. When the use of the content of the cluster is an instance of reproduction of this content, this step is also called visualization.

The use of a content is notably its production on a screen, its integration into a complex multimedia content: such as a book, an album, a calendar, a movie, etc., by a content processing tool.

Thus, the use, in particular the viewing, of the content of the library is interactive.

In particular, the reading [symbol] of the last content of a cluster CLₙ_{_}c_{M} brings about the use US of this last content of a cluster CLₙ_{_}c_{M} and the end of use ⊙ of the cluster CLₙ currently being used.

In particular, the use of a cluster CL_US can be stopped by the user U by means notably of a request to end use of a cluster stp_req. For example, the end request stp_req is received by virtue of the successive reading of content [symbol] . Instead of reading the following content of the cluster currently being used CLₙ, the reception of the end request stp_req triggers the end of use ⊙ of the cluster CLₙ currently being used.

In particular, the end of use of a cluster ⊙ riggers trg the generation of new content clusters CL_GEN according notably to the content of the previously used cluster CLₙ.

In particular, the determination CR_DT of the criteria

$${\{ {cr}_{ij} \}}_{{i = 1 … N}_{j = 1 … {K}_{i}}}$$

is dependent on at least one of the items of content of the cluster whose use has just been finished {CLₙ_{_}cₘ}_{1≦m≦M}.

In particular, the method for use PUC comprises an instance of selection CL_SLCT by the user U of a cluster thus generated according to content of the cluster whose use has just finished.

In particular, the method for using content PUC comprises an instance of use CL_US of the content of a second cluster selected CL_SLCT by the user U. The generation of second content clusters CL_GEN is dependent on a criterion determined according to at least one content of the first cluster being triggered by one of the following events:
the use of the last content of a first cluster,
a cluster exit request from the user stp_req.

Thus, the use of the content of the library is interactive and evolutionary.

In particular, the determination CR_DT of the criteria

$${\{ {cr}_{ij} \}}_{{i = 1 … N}_{j = 1 … {K}_{i}}}$$

is dependent on the command cmd for selection of the cluster CLₙ. Thus, the selection of a first cluster from a plurality of first generated clusters will be taken into account for the subsequent generation of clusters or generation of second clusters. For example, the new criteria will be dependent on the criteria associated with the first selected cluster, or dependent on criteria that are associated with the first selected cluster and from which the criteria in common with the other first clusters will have been picked up.

In particular, the determination CR_DT of the criteria

$${\{ {cr}_{ij} \}}_{{i = 1 … N}_{j = 1 … {K}_{i}}}$$

is dependent on at least one action by the user in relation to at least one content of the cluster whose use has just finished.

For example, a pause action on a content of the cluster will give rise to the fact that the criteria are dependent on information items relating to this content, and a fast forward action on a content of the cluster will give rise to the fact that the criteria are not dependent on information items relating to this content. In a general manner, a weight is assigned to a content according to an action on the content and the criteria are determined according to the information items relating to the content of a cluster, which information item is factorized by the weight assigned to the corresponding content.

In particular, the criteria are determined according to at least one information item among the following:
information item sc_{1—}el relating to the first content,
information item sc_{m—}el relating to previously used content of a cluster,
information item sc_{m—}act relating to at least one action act by the user U in relation to at least one content of at least one previously used cluster,
information items relating to at least command cmd for selecting a cluster form the user U.

In particular, the method for use PUC comprises an instance of backup WR of all or some of the information items of a cluster allowing determination of the cluster generation criteria, notably at the end of the use of the cluster ⊙. These data ds are notably backed up in a backup database.

In particular, the method for using content PUC comprises an instance of backup WR of data ds. The backed up data ds have at least some of the information items relating to used content c₁, cₘ, criteria crᵢⱼ, to commands cmd for selecting the use and to actions act by the user U during the use.

Thus, the information items used for the determination of criteria for the use will allow generation of clusters in a future instance of use.

Thus, the information items relating to the use of a first cluster can be used for the generation CL_GEN of second clusters (that is to say of clusters among which at least one will be able to be used directly after the use of the first cluster), but also for the generation CL_GEN of subsequent clusters: third, fourth, etc., clusters (that is to say of clusters among which at least one will be able to be used directly or otherwise after the use of a second cluster following the use of the first cluster).

The backup of the data also makes it possible to take account, for an instance of use of the content PUC, of a previous instance of use of this content by the user U. Thus, a user U, who has used the content library BBL a first time by means of the method for use PUC according to the invention, will receive suggestions, by the method for use PUC, at the time of a second instance of use of the content library BBL, of clusters generated not only according to a content selected by the use when this second use starts but also according to the content used previously during the first use.

In particular, the criteria are determined according to information items relating to at least one instance of use of content of the library among the following instances of use:
an instance of use in progress,
at least one previous instance of use, the criteria being dependent on data backed up during the preceding use.

Thus, the use of the library evolves according to the user's current interest in use and/or the user's general interest in use.

In particular, the criteria are determined according to information items relating to at least one previous instance of use of content of the library by a predefined group of users.

Thus, the clusters suggested to a user are dependent on content visualized, for example, by other users of the method for use according to the invention either taken individually or collectively, notably friends of the user, for example a community of friends in a social network, or friends in an address book or a group of friends sharing the content library.

In particular, the method for use PUC comprises an instance of use US of a content associated with a bridge between the content of one cluster and a content of another cluster CL_{|1}_{_}c_{μ1}, CL_{|2}_{_}c_{μ2}) triggering an instance of suggestion of selection of the other cluster BRDG. The selection CL_SLCT of the other cluster CLₗₙₖ allows the triggering of an instance of use US of the content of this other cluster CLₗₙₖ beginning with the content associated with the bridge in this other cluster.

In particular, the method for use PUC comprises a bridge BRDG triggered by the use of a content of one cluster linked to a content of another cluster.

Notably, the bridge BRDG supplies the cluster CLₗₙₖ, linked to the cluster currently being used, to the cluster selection CL_SCT allowing the user U to control cmd the use of the linked cluster CLₗₙₖ, in particular from the content linked to the content currently being used.

Thus, it is suggested that the user navigate between the various generated clusters, thus allowing an instance of use of all of these clusters rather than just of a single one.

For example, in the case of an instance of reproduction of a photograph cluster “Football match” of a user Tom that has a photograph of his friend Bob, during the reproduction of this photograph of his friend Bob, the method for use could suggest Tom selects a cluster linked to this photograph, for example a “Grill night” cluster corresponding to an event that took place at the house of his friend Bob. The bridge between these two clusters is based on this “friend Bob”.

In particular, the method for use PUC comprises an instance of detection of a link LNK_DTCT between characteristics of content of two clusters (CL_{|1}, CL_{|2}).

The cluster generation CL_GEN comprises, notably, an instance of detection of a link LNK_DTCT between two items of content of separate clusters (CL_{|1}_{_}c_{μ1}, CL_{|2}_{_}c_{μ2}). Thus, the use of one of these two items of content (if one of these two clusters has been selected CL_SLCT) triggers a bridge BRDG to the other cluster CLₗₙₖ

Thus, the burden of processing is reduced because the link detection uses an analysis of the criteria allowing the clusters to be generated.

In particular, the method for use PUC comprises an instance of creation of a bridge BRDG_CREA receiving the detected link (CL_{|1—}c_{μ1}, CL_{|2}_{_}c_{μ2}) and associating this link with the two linked items of content either in a cluster database BDD_CL, or in the content library BBL, or in a link database (not illustrated), or directly on the cluster use CL_US when one of the linked clusters is selected CL_SLCT.

Notably, the method for use PUC comprises an instance of creation of a bridge between clusters BRDG_CREA. For example, a bridge is set up between a content c_{μ1} of one cluster CL_{|1} and a content c_{μ2} of another cluster CL_{|2} as soon as a link between characteristics of the content of the cluster and characteristics of the content of the other cluster is detected.

Notably, the detection of a link LNK_DTCT triggers an instance of creation of a bridge BRDG_CREA between these items of content of these two clusters (CL_{|1}_{_}c_{μ1}, CL_{|2}_{_}c_{μ2}).

Thus, the use of the content will allow movement from one content cluster to another without new cluster generation. The bridges between clusters will promote the use of all of the generated clusters.

In particular, the cluster generation CL_GEN is based on the links between content in order to generate the clusters.

The clusters are notably recorded in a cluster database BDD_CL, for example up until the next cluster generation.

In particular, the method for using content PUC comprises, therefore, an instance of selection of a cluster CL_SLCT at the command cmd of the user U from the following:
the generated clusters CL₁ . . . CL_{N},
another cluster CLIₙₖ linked to the cluster currently being used by means of a bridge between a content of the cluster currently being used and the content of this other cluster.

One embodiment of the method for using content PUC is a program comprising program code instructions for executing the steps of the method for using content when said program is executed by a processor.

The method for using PUC content of a library according to the invention can also be illustrated by the sequential diagram in FIG. 2. The use of the library is dynamic because it suggests the user look through the content library in suggested clusters that he or she chooses or does not choose to consult. These clusters may be suggested at regular or irregular intervals, that is to say at the end of a predefined period of time, at the end of the use of a cluster (all the clusters being of identical or nonidentical size, in terms of amount of content and/or period of use), when a content linked by a bridge to another cluster is read, etc.

The content of the library is, in particular, tagged partially or fully with additional information items, such as:
context characteristics (place, date, time, point of interest, etc.)
capture characteristics (luminosity, exposure, orientation, etc.)
reproduction format (dimensions, compression, weight, etc.)
subject characteristics obtained notably by means of intra-content analysis (typology of photographs, persons present, texts, associated concepts, etc.)
belonging (person who owns the hardware, author and/or processor of the content, etc.).

The use can be broken down into four distinct phases:

1°) the onset, which consists in selecting c_SLCT a first content c1, or initial content, whose singular characteristics will be read, analyzed and then compared CR_DT with the rest of the library of the user;

2°) the clarification, which consists in suggesting the various generated clusters CL_GEN in connection with the initial content c1 and/or the previously used cluster CLₙ, and in selecting one of them, CLₙand CL_{q} respectively;

3°) the use US, which consists in using, notably in displaying, successively or simultaneously, the content of the selected cluster;

4°) the interruption ⊙ which consists in putting an end to the use sequence.

FIG. 2 shows that phases 2 of clarification and 3 of use can be repeated until they are interrupted.

For example, in the case of an instance of use for the viewing of a library of photographs:

### 1°) Onset:

A user Simon initiates the method for use PUC by selecting a first photograph c1: a photograph of him on holiday in <Barcelona>with his friends <Paul>, <Noah>and <Kate>taken at <21:23>on <11/08/2014>while they are playing with a <ball>on the <beach><facing West>and captured at <1/500 f5.6 500iso>

The characteristics associated with this photograph c1 are as follows:
<Barcelona>which comes from GPS data
<Paul><Noah><Kate>, who have been determined by intra-content analysis based on face recognition
<21:23>which comes from the context data created on capture
<11/08/2014>which comes from the context data created on capture
<ball>which has been determined by intra-content analysis based on concept analysis
<beach>which has been determined by intra-content analysis based on photograph typology analysis
<facing West>which comes from the context data created on capture
<1/500 f5.6 500 iso>which comes from the context data created on capture

### 2°) Clarification

The method for use PUC then generates CL_GEN 3 clusters:
the 1^{st} cluster has the main characteristics crᵢⱼ=<common location>+<common persons>+<common temporality>. In this cluster, Simon therefore finds all photographs of this same holiday in Barcelona and its surroundings where either Paul or Noah or Kate are present.
the 2^{nd} is organized around the characteristics crᵢⱼ=<concepts>+<beach>. In this cluster, Simon finds all photographs where he or she has been able to play with a ball (football, rugby ball, etc.) on the beach (in Barcelona, in Saint Malo, in Noirmoutieror elsewhere).
the 3^{rd} groups the contents in connection with crᵢⱼ=<capture settings>and <time>. In this cluster, Simon relocates photographs where rapid movement has been captured (sport, dance, vehicle, etc.) at the same time of the day (evening).

Simon has decided to click CL_SLCT on the 2^{nd} cluster CLₙ.

### 3°) Visualization

Simon then accesses the cluster CLₙ in question and visualizes US the content that has the characteristics thereof, that is to say the content grouped by this cluster, for example in the form of a slide show of the content of the selected cluster.

The automatic scrolling can be slowed down at his request. All of his actions allow measurement of whether he stops mainly on photographs where <himself>is present while playing <football>. This allows the next clusters to be conditioned according to these characteristics.

Thus, the clusters suggested in future may potentially be of the type:
All content where Simon is playing with a ball.
All content where Simon is at the heart of action.
All content containing action with a ball.
Etc.

### 4°) Interruption ⊙

Simon completes his or her slide show. Some of the information items from this session is backed up as providing use habits in order to improve subsequent viewings.

FIGS. 3a and 3b illustrate simplified diagrams of the links between the characteristics of the content, and content clusters, respectively, according to the invention.

The method for use PUC notably firstly comprises an indexing of the content of the library BBL. The library is either co-located or spread (over various peripherals and/or in the cloud and/or in any other storage solution(s), etc.). Next, the method for use comprises an analysis that is capable notably of matching similar characteristics of content of the library (for example all photographs taken at such a time and/or on such a date and/or in such geographical regions, etc. are potentially from the same shooting context, etc.). This analysis also allows notably intra-content connections (detection of persons present, of luminosity, of countryside, etc., for example). This analysis is a link detection, in particular.

The method for use PUC is then in possession, with this set of links, of a virtual mapping that is illustrated by FIG. 3a for the interconnections existing over the whole library. These are all bridges between the content. These links are more or less logical and conditioned by the use context, for example two photographs share the same exposure characteristic <long exposure>, which may make sense to an astronomy enthusiast taking pictures of the sky.

FIG. 3a shows a library comprising a plurality of items of content cₐ . . . c_{z}, some of which are linked to one another by criteria crα . . . crπ. For example, the items of content cₐ, c_{c}and cₑ are linked to one another by a criterion crα: the items of content c_{d}, c_{f}, cₓ and c_{y} are linked to one another by a criterion crβ . . . ; the items of content c_{b}, c_{d} and c_{f} are linked to one another by a criterion crπ.

On the networking of FIG. 3a, the method for use PUC applies rules for generating relevant clusters CL_GEN that are shown by FIG. 3b: CL1, CL2 . . . CLn . . . CLq.

The user U looks through the content of a cluster CL_US and can, if he or she so desires, take one of the bridges BRDG to another cluster.

For example, the user first of all selects the cluster CLₙ, uses the content c₁, and then c₂of this cluster CLₙ. There, the method for use PUC suggests he or she take the bridge to the cluster CL₁, or the bridge to the cluster CL₂. If the user chooses the cluster CL₁, he or she will first of all use the content c1 of this cluster CL₁ . . . therein.

FIG. 4 illustrates an abstract diagram of the dependence between the route for use of a content library and evolutionary criteria, according to the invention.

The concept of the invention is based on active construction of the use of the content via links between items of content conditioned by choices by the user (criteria determined according to the content used, the actions of the user on this used content, etc.).

In parallel with this nonlinear perception of the content library, the route of the user in the library (illustrated in the left-hand circle) is kept up to date through a series of evolutionary indicators (illustrated in the right-hand circle) influencing the actions at his or her disposal (CL_SLCT) and providing evidence of his or her route.

The route in the content library (c₁, CLₙ_{_}c₁, CLₙ_{_}c₂, CLₙ_{_}c₃ , CL_{q}_{_}c₁CL_{q}_{_}c₂ . . . CL_{q}_{_}cₘ) is therefore modifiable while being used, it generates CR_DT indicators or criteria (data stemming from the choices by the user: cₘ_{_}act, cₘ_{_}el, cmd, c₁_{_}el) and these indicators influence the route (notably the clusters generated CL_GEN one of which will be selected by the user U).

Thus, the method for using a content library according to the invention allows the user to navigate through his or her content (c₁, CLₙ_{_}c₁, CLₙ_{_}c₂, CLₙ_{_}c₃, CL_{q}_{_}c₁, CL_{q}_{_}c₂ . . . CL_{q}_{_}cₘ) in the manner of a story in which he or she is the hero or heroine. Each theme (content cluster: CLn, CLq) of content use is inserted with the user taking a decision regarding the thematic trail that he or she resolves to follow.

FIG. 5 illustrates a simplified diagram of a device for using content of a library according to the invention.

The device for using content 11 of a content library comprises a cluster generator 110. The generator 110 supplies, following an instance of use of at least one content of a library, a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

Possibly, a terminal 1 comprises:
A module for using content (12, 14), and
A cluster generator 110 supplying, following an instance of use of at least one content of a content library, a plurality of content clusters from the content of the library according to one or more criteria associated with the clusters, the criteria having been determined according to at least one content previously used by the module for use, the generated clusters being selectable by a user, an instance of selection of a cluster triggering an instance of use of the content of the selected cluster.

For example, the terminal 1 comprises the device for using content 11 comprising the cluster generator 110.

In particular, the device for use 11 and/or the terminal 1 comprises a content selector 111 for selecting content from a content library 10a, 20. Notably, the selector 111 receives a content request c1_req from the user U by means of a user interface 13. The terminal 1 possibly comprises the user interface 13.

In particular, the content library BBL is included in the terminal 1: library 10a, and/or directly in the device for use 11 (not illustrated), and/or is external to the terminal 1 and to the device for use 11: library 20 of a piece of equipment 2 (not illustrated) that is local to the terminal 1 or remote (that is to say accessible by the terminal 1 via a communication network). In the case of a library 20 in another piece of equipment, the terminal 1 possibly comprises an access module 10b for accessing the library 20.

In particular, the content selector 111 supplies the selected content to a module for use such as at least one reproduction module 12, notably a screen, a projector, a loudspeaker, etc., or a content processing module 14.

In particular, the device for use 11 and/or the terminal 1 comprises a determination module 112 for determining criteria

$${\{ {cr}_{ij} \}}_{{i = 1 … N}_{j = 1 … {K}_{i}}}$$

according to the content c1 selected by the user U, in particular the content c1 currently being used. Notably, the determination module recovers characteristics of the selected content c1 such as metadata, data tattooed in the content, etc., and/or analyzes the content in order to recover one or more characteristics therefrom. The determination module 112 comprises, notably:
a recognition module, such as a face, text, monument and/or countryside, etc., recognition module,
and/or a concept analyzer,
and/or a topology analyzer,
etc.

In particular, the determination module 112 supplies the cluster generator 110 with criteria

$${\{ {cr}_{ij} \}}_{{i = 1 … N}_{j = 1 … {K}_{i}}}$$

according to at least one previously used content, such as at least the first selected content c1

In particular, the device for use 11 and/or the terminal 1 comprises a cluster database 114 in which the clusters generated in this manner are recorded up until at least the next cluster generation.

In particular, the device for use 11 and/or the terminal 1 comprises a cluster selector 113 receiving the clusters CL₁ . . . CL_{N} generated by the cluster generator 110. The selector is notably controlled cmd by the user U by means of the user interface 13. Thus, the user U selects a cluster from the generated clusters CL₁ . . . CL_{N} in order to use it.

In particular, this cluster selection command is also received by the criteria determination module 112, thus allowing the cluster generator 110 to take account of this command for the generation of new clusters.

In particular, the device for use 11 and/or the terminal 1 comprises a module for using clusters 115 that is capable of successively and/or simultaneously reading the content of a content cluster. The module for using clusters 115 notably receives the selected cluster supplied by the cluster selector 113. The module for using clusters 115 supplies the read content CLₙ_{_}cₘ to a module for use, notably one of the modules for using content 114 according to the desired use. In an embodiment that is not illustrated, the module for using clusters 115 has a module for using content such as a reproduction module and/or a content processing module.

In particular, the module for using clusters 115 is capable of receiving actions c_{m—}act of the user U in relation to the content currently being used cₘ, notably by means of the user interface 13. For example, the actions are actions for reading the content, read, pause, fast forward, return to the first content of the cluster, etc., successive or simultaneous reading, etc.

In particular, these actions are received by the module for determining criteria 112, thus allowing the cluster generator 110 to take account of these actions when generating new clusters.

In particular, the module for using clusters 115 is capable of commanding the cluster generator 110 to trigger trg the generation of new clusters, notably when the current use of the cluster is terminated, or when the user U requests that the current use of the cluster be stopped, for example by means of a stop request stp_req sent by the user interface 13.

In particular, the device for use 11 and/or the terminal 1 comprises a backup database 116 that backs up all the data used by criteria 112. The writing to the backup database 116 is notably controlled by a request to end use from the user interface 13 putting an end to the current use of the library, and/or by the interruption of the use of a cluster by the module for using clusters 115.

In particular, the cluster generator 110 and/or the device for use 11 and/or the terminal 1 comprises a link detector 1101 detecting, during the generation of clusters, a link between a content of one cluster and a content of another cluster (CL_{|1}_{_}c_{μ1}, CL_{|2}_{_}c_{μ2}).

In particular, the device for use 11 and/or the terminal 1 comprises a bridge generator 117 that is capable of generating a bridge between two items of content of two separate clusters. This bridge is supplied directly to the module for using clusters 115 if the cluster has been selected, and/or is recorded in the cluster database 114 and/or the library 10a, 20. In particular, the bridge generator 117 devises a bridge when the link detector 1101 supplies a link between two separate clusters (CL_{|1}_{_}c_{μ1}, CL_{|2}_{_}c_{μ2}).

Thus, the module for using clusters 115 reading the linked content of a cluster in order to supply it to the module for using content 12, 14 indicates to the user the possibility of using the other cluster linked by a bridge to the cluster currently being used and allows it to select this other cluster by commanding the cluster selector 113 to select it by virtue, for example, of the user interface 13.

In particular, the device for use 11 and/or the terminal 1 comprises a bridge module 118 connected to the module for using clusters 115 and capable of controlling the cluster selector 113 in order to suggest the selection of the linked cluster CLₗₙₖ to the user U. For example, the bridge module 118 detects the content linked to another cluster when said content is read by the module for using clusters 115. The bridge module 118 looks, notably, for the other cluster when either the bridge module 118 or the module for using clusters 115 detects the use of a linked content. For example, the bridge module 118 looks for the other cluster in the metadata of the linked content, the library 10a, 20 and/or the cluster database 114.

The aim of the invention is also a medium. The information storage medium may be any entity or device that is capable of storing the program. For example, the medium may have a storage means, such as a ROM, for example a CD-ROM or a microelectronic circuit ROM, or else a magnetic recording means, for example a floppy disk or a hard disk.

Moreover, the information storage medium may be a transmissible medium such as an electrical or optical signal that can be forwarded via an electric or optical cable, by radio or by other means. The program according to the invention can be, in particular, downloaded on a network, notably of Internet type.

Alternatively, the information storage medium may be an integrated circuit in which the program is incorporated, the circuit being adapted to execute or to be used for executing the method in question.

In another implementation, the invention is brought about by means of software and/or hardware components. From this perspective, the term module can correspond either to a software component or to a hardware component. A software component corresponds to one or more computer programs, one or more subroutines of a program or, more generally, to any element of a program or of a piece of software that is capable of performing a function or a set of functions according to the description below. A hardware component corresponds to any element of a hardware assembly that is capable of performing a function or a set of functions.

1. Method for using content of a content library comprising, following an instance of use of at least one content of a library:
an instance of generation of a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

2. Method for using content according to claim 1, wherein the method for using content comprises an instance of selection of a cluster at the command of the user from among the following:
the generated clusters,
another cluster linked to the cluster currently being used by means of a bridge between a content of the cluster currently being used and a content of this other cluster.

3. Method for using content according to claim 1, wherein the method for using content comprises an instance of use of a first content selected by the user from the library, the use of the first content triggering the generation of content clusters according to one or more criteria determined according to the first content.

4. Method for using content according to claim 1, wherein the method for using content comprises an instance of use of the content of a selected cluster triggered by the selection of said cluster at the command of the user.

5. Method for using content according to claim 1, wherein the method for using content comprises an instance of use of the content of a second cluster selected by the user, the generation of a second content cluster according to criteria determined according to at least one content of the first cluster being triggered by one of the following events:
the use of the last content of a first cluster,
a cluster exit request from the user.

6. Method for using content according to claim 1, wherein the criteria are determined according to at least one information item among the following:
information items relating to the first content,
information items relating to previously used content of a cluster,
information items relating to at least one action of the user in relation to at least one content of at least one previously used cluster,
information items relating to at least one cluster selection command from the user.

7. Method for using content according to claim 1, wherein the criteria are determined according to information items relating to at least one instance of use of content of the library among the following instances of use:
an instance of use in progress,
at least one previous instance of use, the criteria being dependent on data backed up during the preceding use.

8. Method for using content according to claim 1, wherein the method for using content comprises an instance of data backup, the backed up data comprising at least some of the information items relating to used content, criteria, to selection commands for the use and to actions by the user during the use.

9. Method for using content according to claim 8, wherein the method for use comprises an instance of detection of a link between characteristics of content of two clusters, with the detection of a link triggering an instance of creation of a bridge between this content of these two clusters.

10. Method for using content according to claim 9, wherein the link detection is carried out during the cluster generation.

11. Method for using content according to claim 1, wherein the method for use comprises an instance of creation of a bridge between clusters, a bridge being set up between a content of one cluster and a content of another cluster as soon as a link between characteristics of the content of the cluster and characteristics of the content of the other cluster is detected.

12. Method for using content according to claim 1, wherein the method for use comprises an instance of use of a content associated with a bridge between the content of one cluster and a content of another cluster triggering an instance of suggestion of selection of the other cluster, the selection of the other cluster allowing triggering of an instance of use of the content of this other cluster beginning with the content associated with the bridge in this other cluster.

13. A Program comprising program code instructions for executing steps of a method for using content when executed by a processor, the method for using content of a content library comprising, following an instance of use of at least one content of a library: an instance of generation of a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

14. Device for using content of a content library comprising a cluster generator, the generator supplying, following an instance of use of at least one content of a library, a plurality of content clusters from the content of the library according to one or more criteria associated with the clusters, the criteria having been determined according to at least one previously used content, the generated clusters being selectable by a user, an instance of selection of a cluster triggering an instance of use of the content of the selected cluster.

15. Terminal comprising:
a module for using content
a cluster generator supplying, following an instance of use of at least one content of a content library, a plurality of content clusters from the content of the library according to one or more criteria associated with the clusters, the criteria having been determined according to at least one content previously used by the module for use, the generated clusters being selectable by a user, an instance of selection of a cluster triggering an instance of use of the content of the selected cluster.
